(19) United States
(12) Patent Application Publication
(10) Pub. No.: US 2006/0048361 A1
(43) Pub. Date: Mar. 9, 2006

(54) Double-spindle machine-tool

(76) Inventors: Ioan-Mircea Corbean, Marbach (DE); Gerald Stengele, Ludwigsburg (DE)

Correspondence Address: MCGLEW & TUTTLE, PC, P.O. BOX 9227, SCARBOROUGH STATION, SCARBOROUGH, NY, 10510-9227, US

(21) Appl. No.: 10/542,172

(22) PCT Filed: Dec. 11, 2003
(86) PCT No.: PCT/EP03/14044

§ 371 Date: Jul. 13, 2005

(30) Foreign Application Priority Data
Jan. 25, 2003 (DE) 203 01 126.0

(51) Int. Cl. B23P 23/00

(52) U.S. Cl. 29/27 C; 409/202; 409/192; 409/165

(57) ABSTRACT

A double-spindle machine tool comprises a frame-type stand (1) with an x skid (10) that is displaceable in an x direction and a y skid (15) that is displaceable in a y direction on the x skid (10). Two work holder spindles (20, 21) which are non-displaceable in a z direction are disposed on the y skid (15) for accommodation of tools (26) for machining work pieces (41, 42) that are located in a working area (7). In the working area (7) provision is made for at least one z skid (28) which is displaceable in the z direction, having two work carriers (39, 40) disposed on it for accommodation of the work pieces (41, 42).

The invention relates to a double-spindle machine tool. DE 101 19 175 A1 teaches a machine tool of the generic type by means of which to machine two work pieces in parallel. This machine tool comprises a frame on which an x skid is disposed horizontally, with two vertically displaceable y skids disposed thereon. A tool holder spindle which is movable in the z direction is disposed on the y skid. Two work carriers are stationary in the working area with work pieces being chucked that are to be machined. Long working paths in the z direction will lead to the work holder spindles sagging. The negative effects of this sagging on the precision of the machining process can be balanced only by complicated compensation methods. For high precision machining in particular of deep bores that need especially precise motion in the z direction, machine tools which have only a single tool holder spindle have become known; they are designed for displaceability in the z direction of the work carrier that carries the work piece.

It is an object of the invention to embody a double-spindle machine tool in such a way that high precision machining is possible.

According to the invention, this object is attained by the features of claim 1. The measures according to the invention help attain high-precision displacement of the work piece in the z direction, with the machining tools being non-displaceable in the z direction. As a result of the development according to claim 2, high precision rotating or pivoting of the work becomes possible and any necessary compensations can easily be implemented.

With two z skids being provided according to claim 4, any compensation motions in this direction that might be necessary can be put into practice very easily. The same applies if two y skids are provided according to claim 7. Finally, if two x skids are additionally provided in accordance with claim 8, compensations in this direction can be implemented very easily.

Claims 9 and 10 reflect preferred drives.

Further features, advantages and details of the invention will become apparent from the ensuing description of exemplary embodiments, taken in conjunction with the drawing, in which

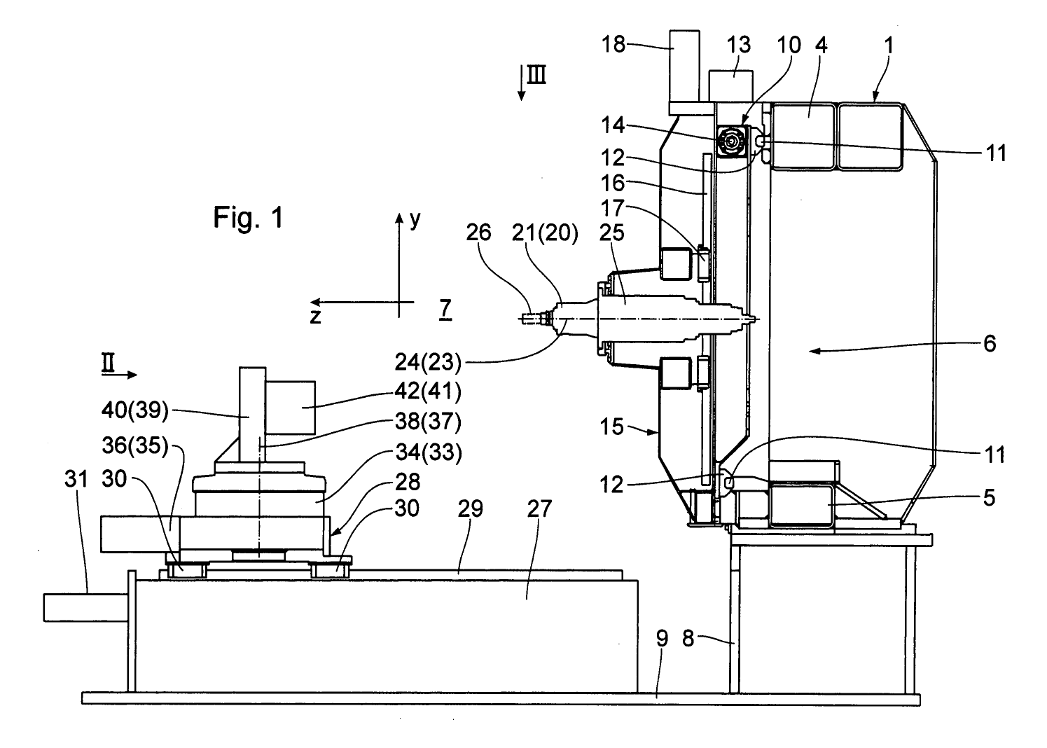

FIG. 1 is a lateral longitudinal view of a first embodiment of a double-spindle machine tool;

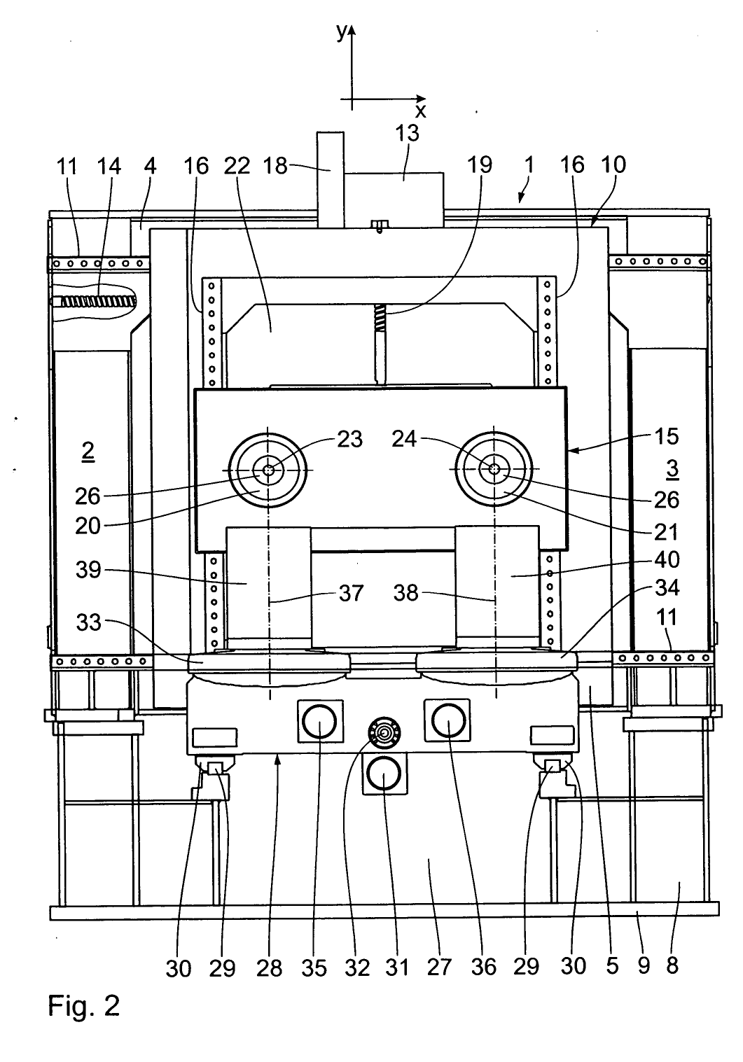

FIG. 2 is a front view of the machine tool according to the arrow II of FIG. 1;

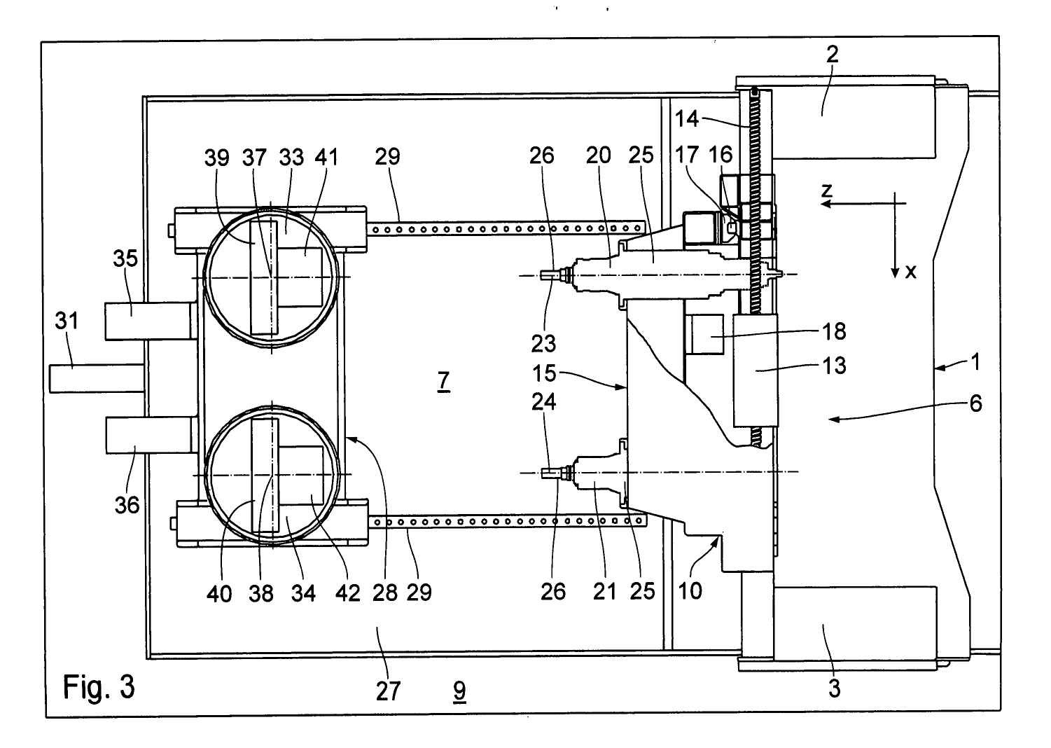

FIG. 3 is a plan view of the machine tool according to the arrow III of FIG. 1;

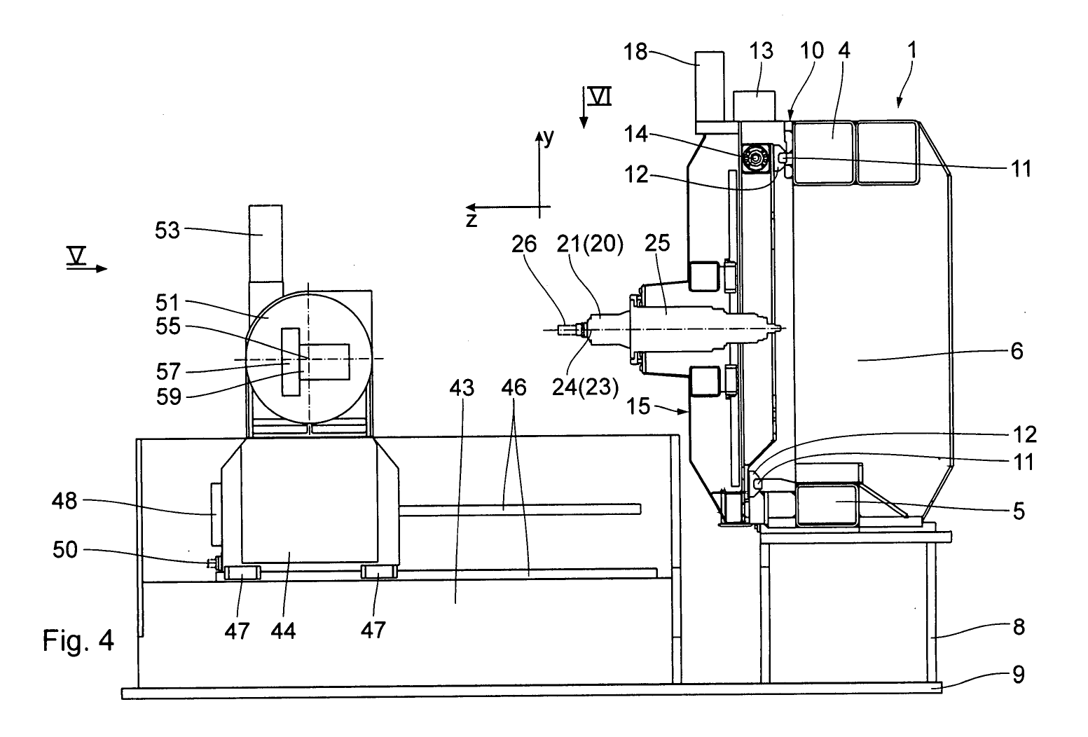

FIG. 4 is a lateral longitudinal view of a second embodiment of a double-spindle machine tool;

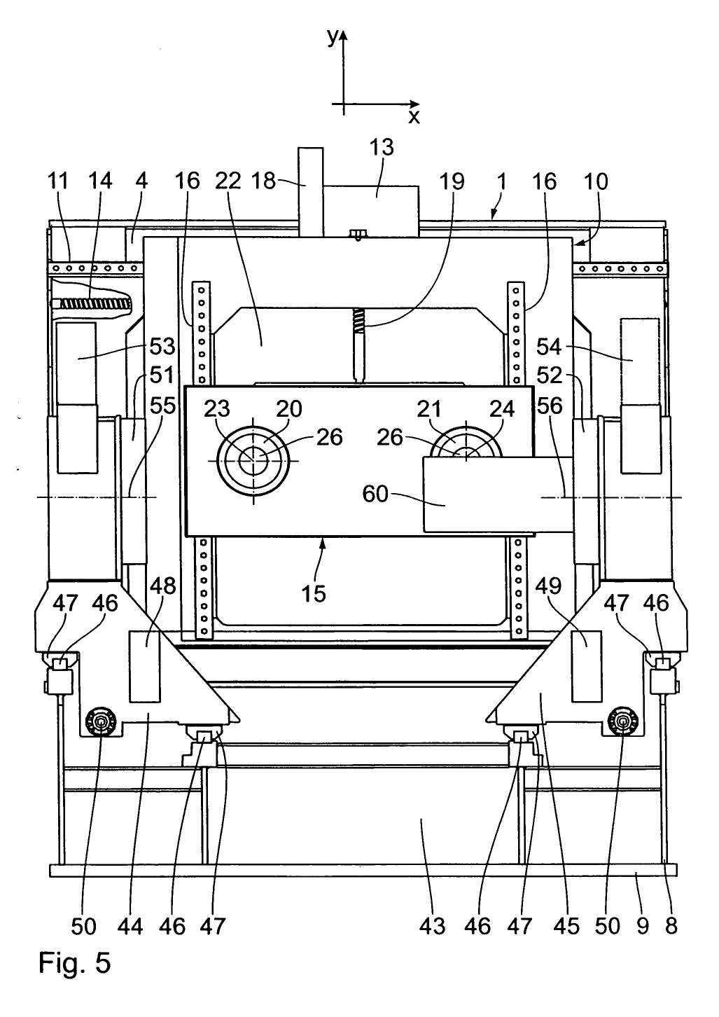

FIG. 5 is a front view of the machine tool according to the arrow V of FIG. 4;

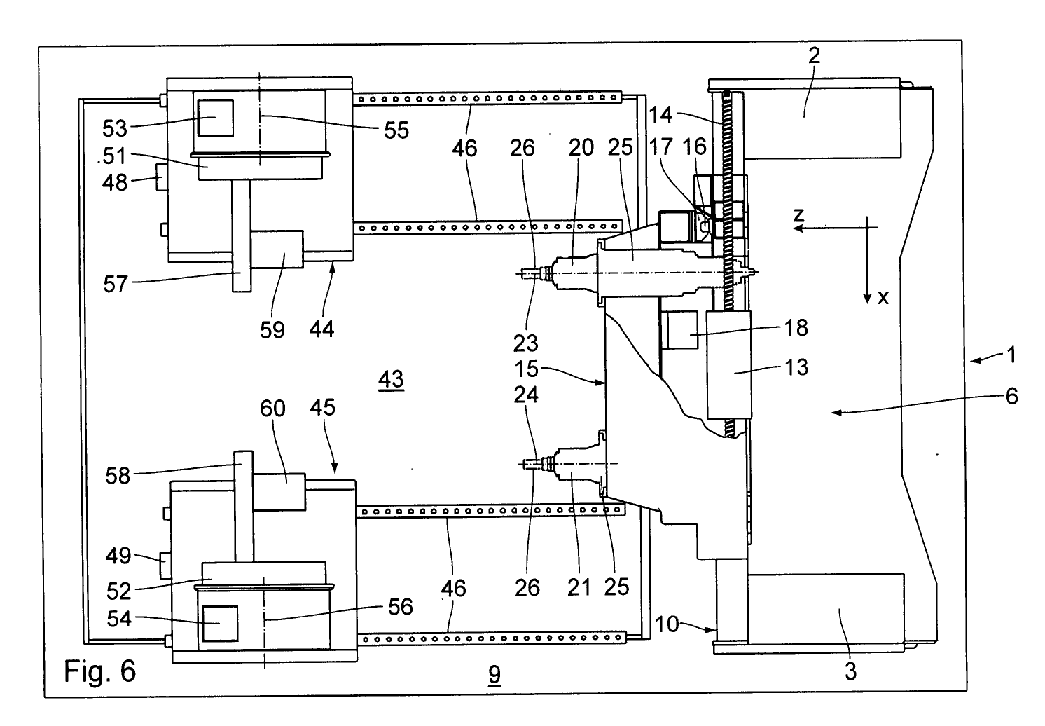

FIG. 6 is a plan view of the machine tool according to the arrow VI of FIG. 4;

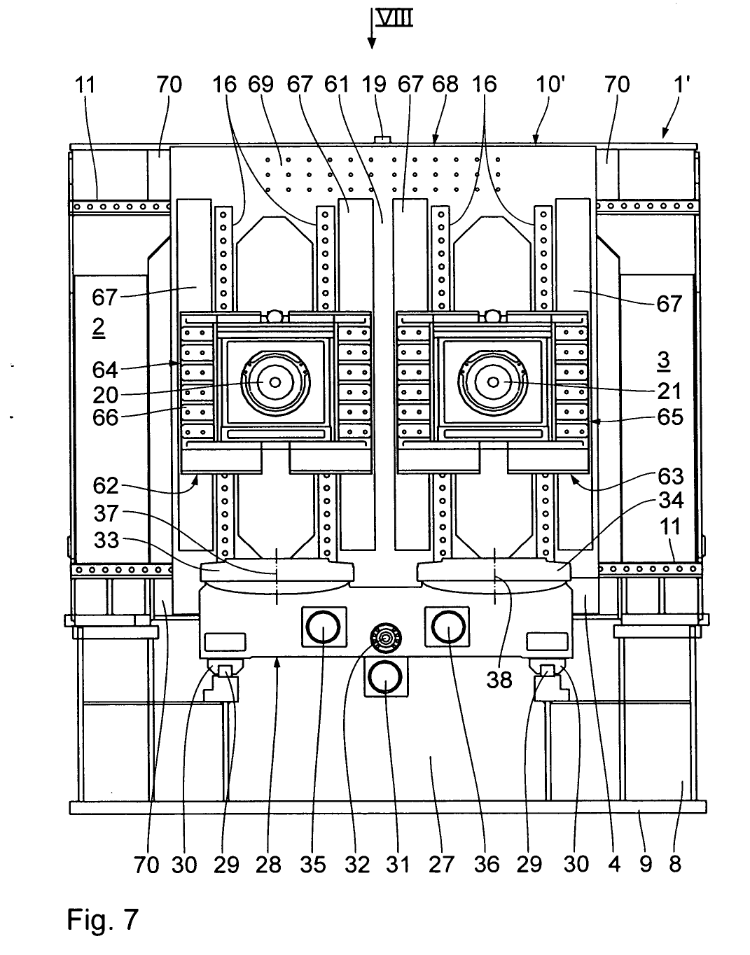

FIG. 7 is a front view of a third embodiment of a double-spindle machine tool;

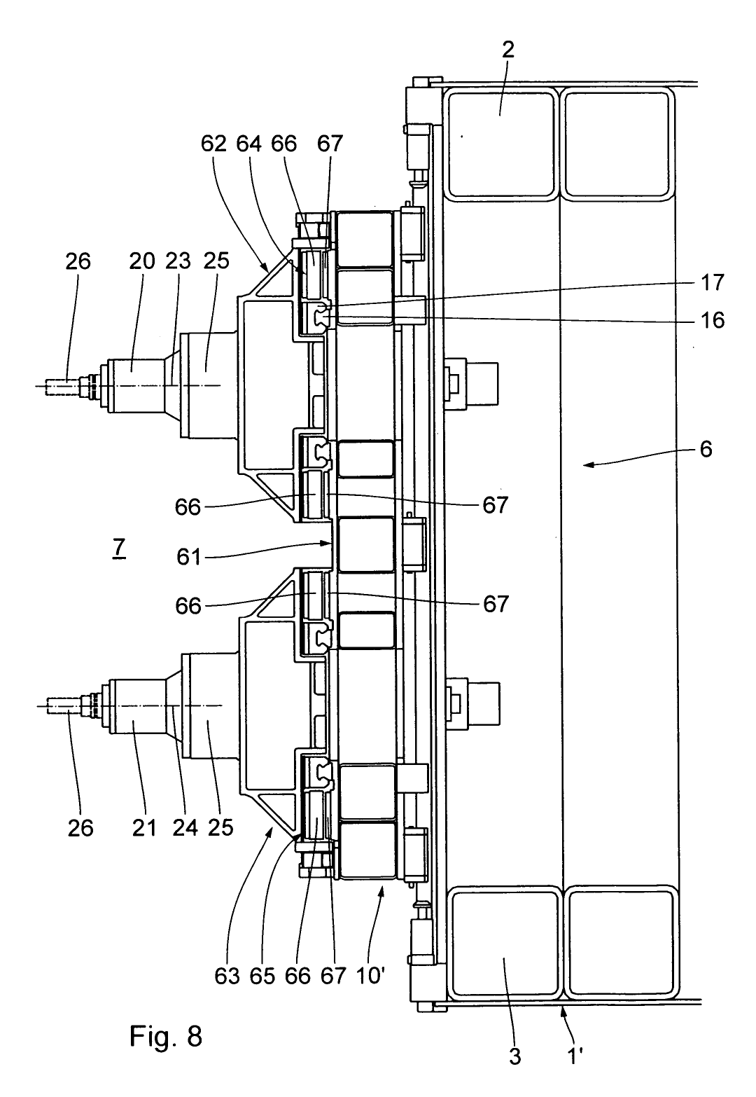

FIG. 8 is a partial plan view of the machine tool according to the arrow VIII of FIG. 7;

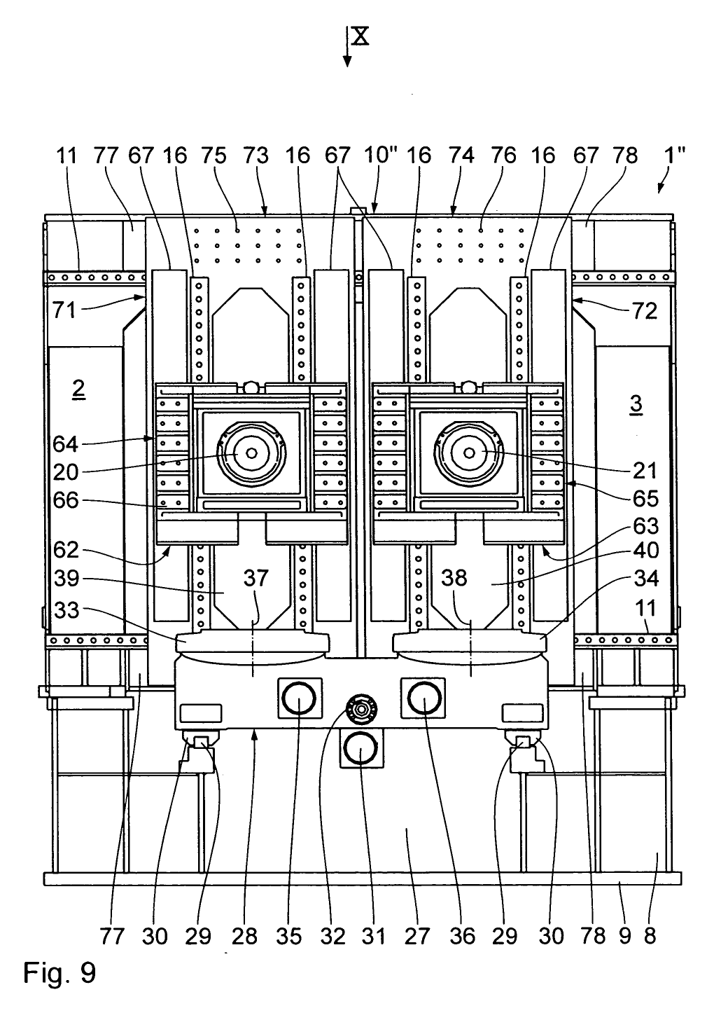

FIG. 9 is a front view of a fourth embodiment of a double-spindle machine tool;

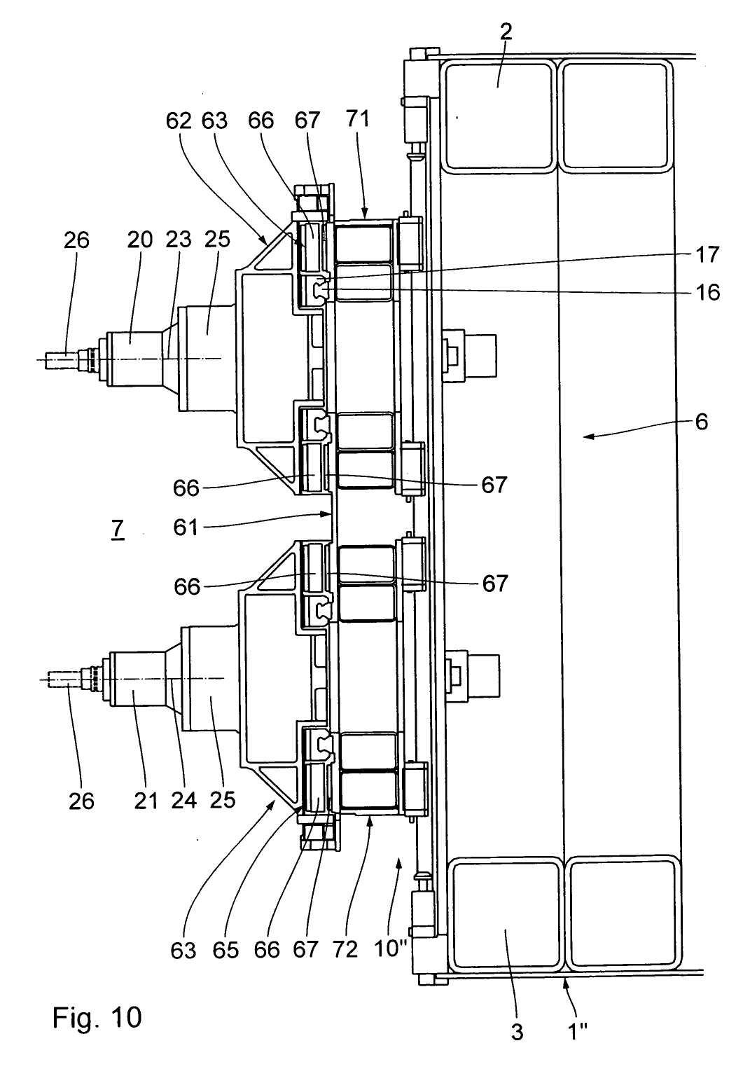

FIG. 10 is a partial plan view of the machine tool according to arrow X of FIG. 9;

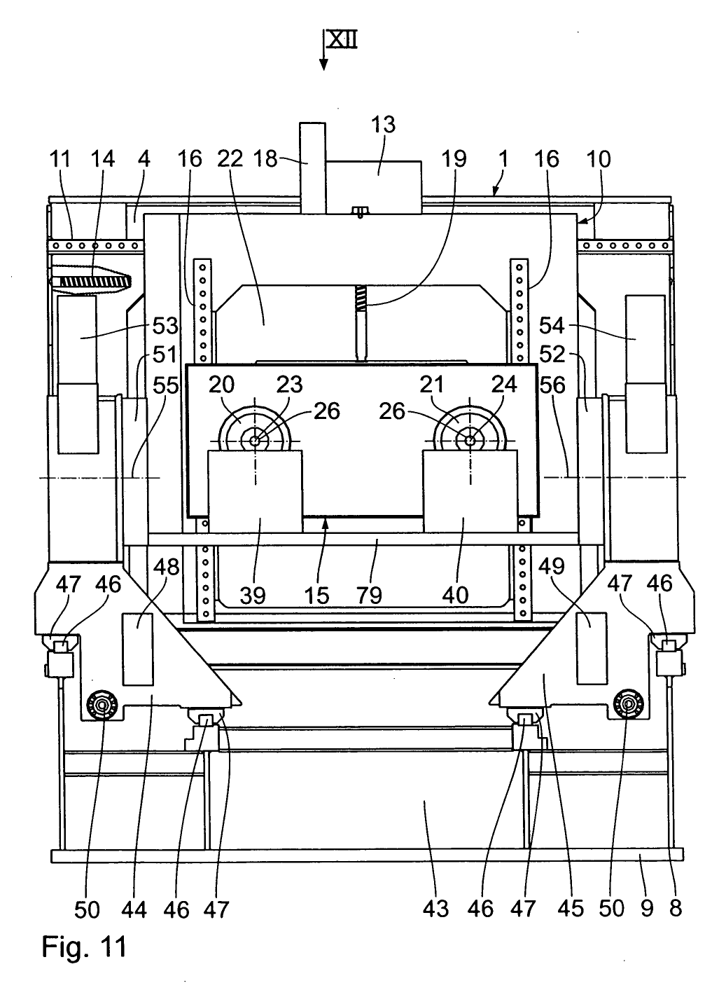

FIG. 11 is a front view of a modified way of application of the machine tool corresponding to the second embodiment; and

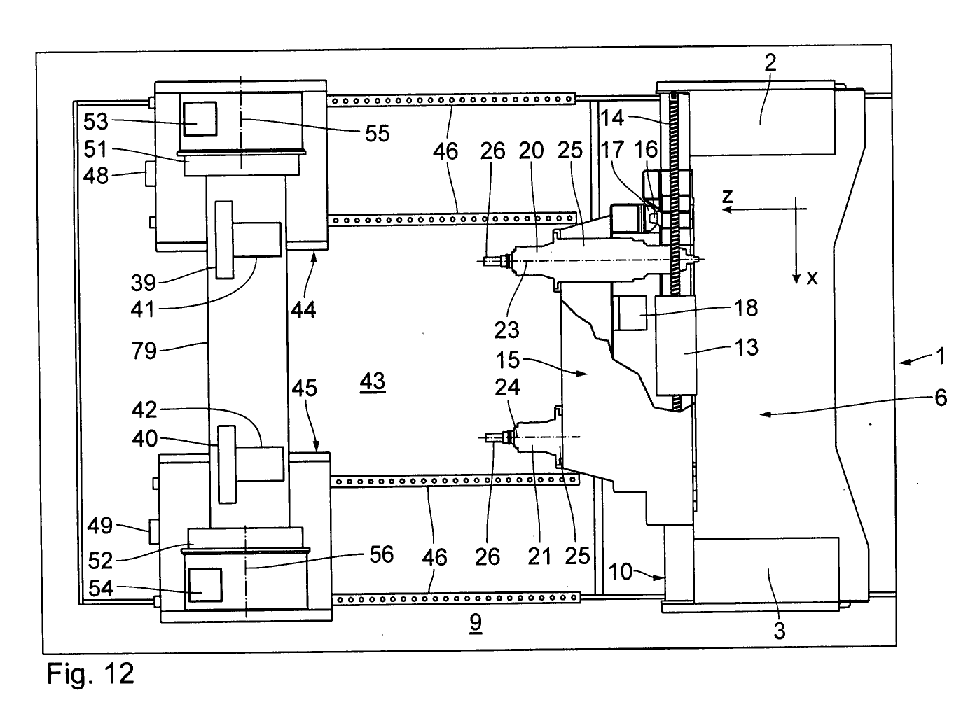

FIG. 12 is a plan view of the machine tool according to the arrow XII of FIG. 11.

The first exemplary embodiment of a double-spindle machine tool illustrated in FIGS. 1 to 3—seen in the horizontal z direction—comprises a rectangular, approximately square stand 1 in the form of a frame which is formed by vertical side props 2, 3 that run in the y direction and by a horizontal top crossbeam 4 that runs in the x direction and unites the props 2 and by a bottom crossbeam 5. The side props 2, 3 and the crossbeams 4, 5 are formed by hollow sections and enclose an interior 6 which is open bilaterally, in particular towards the working area. By way of a subframe, the stand 1 supports itself on the foundation 9 or on a foundation plate 9, respectively.

On the front side, turned towards the working area 7, of the stand 1, provision is made for an x skid 10 in the form of a frame which is movable in the x direction. To this end, the crossbeams 4, 5 are each provided with an x guide rail on which the x skid 10 is guided by means of x guide shoes 12. Actuation of the x skid 10 takes place by means of an x motor 13, which is mounted on the x skid 10, by way of x ball screw 14 which runs in the x direction and is non-rotatably located in the side props 2, 3 of the stand 1.

A y skid 15 which is vertically movable i.e., in the y direction, is guided for displacement on the front side, turned towards the working area 7, of the x skid 10. To this end, a y guide rail 16 is mounted on the respective lateral areas of the frame-type x skid, on which the y skid 15 is guided for displacement by means of guide shoes 17. Actuation of the y skid 15 takes place via a y ball screw 19 by means of a y motor 18 which is also mounted on the x skid 10.

Two tool holder spindles 20, 21 are located at a distance from each other on the y skid 15; they extend in the z direction and forwards towards the working area 7 and backwards through the inner clearance zone 22 of the x skid 10 and into the interior 6 of the stand 1. The tool holder spindles 20, 21 are operable by a drive motor 25 for rotation about an axis 23, 24 which runs in the z direction. The z axes of rotation 23, 24 have a distance from each other in the x direction. On their side turned towards the working area 7, they can each accommodate a machining tool 26. In the x and y direction, the tool holder spindles 20, 21 are mounted stationarily one in relation to the other on the y skid 15, however they are non-displaceable in the z direction.

A work carrier bed 27 is located in the working area 7 in front of the stand 1 on the foundation or foundation plate 9, with a z skid 28 being located thereon for displacement in the z direction. To this end, the bed 27 is provided with z guide rails 29 on which the z skid is movably supported by z guide shoes. Actuation takes place via a z ball screw by means of a z motor 31 which is mounted on the work carrier bed 27.

Two rotary tables 33, 34 are mounted on the z skid 28, each of which being drivable for rotation about a vertical axis of rotation 37, 38 i.e., in the y direction, by means of a rotary drive motor 35, 36. The y axes of rotation 37, 38 also have a distance from each other.

A work carrier 39, 40 is mounted on the y rotary tables 33, 34; it is able to accommodate a work piece 41, 42.

The simultaneous machining of the fundamentally identical work pieces 41, 42 by means of a tool 26 takes place in such a way the identical motions of the tool holder spindles 20, 21 are made in the x and y direction by means of the x skid 10 and the y skid 15. The—in this regard—identical motions of the work pieces 41, 42 in the z direction are performed by the z skid 28. Only the motions of the work pieces 41, 42 about the vertical y axes of rotation 37, 38 will also be fundamentally identical in practice, but can be different at least theoretically because of the independent actuation of the work carriers 39, 40 for rotation about the y axes of rotation 37, 38.

The second embodiment of a double-spindle machine tool illustrated in FIGS. 4 to 6 is identical with the embodiment of FIGS. 1 to 3 in as much as the stand 1 and the x skid 10 and y skid 15 and the tool holder spindles 20, 21 are concerned. In this regard, reference is made to the above description.

A work carrier bed 43 is disposed on the foundation or foundation plate 9; two z skids 44, 45 are disposed thereon in mirror symmetry of one another, related to a y-z center plane. To this end the bed 43 is provided with a pair of z guide rails 46, on which each z skid 44 and 45 is guided for displacement in the z direction by means of z guide shoes 47. Actuation of each z skid 44, 45 takes place via a z ball screw 50 by means of a respective z motor 48, 49 that is mounted on the bed 43.

An x rotary table 51 and 52, respectively, is mounted on the z skids 44, 45 on the side turned towards the respective other z skid 45 and 44; by means of an x rotary drive motor 53, the table 51 and 52 is drivable for rotation about an x axis of rotation 55 and 56 which extends in the z direction. The respective rotary drive motor 53 and 54 is mounted on the associated z skid 44 and 45. Each rotary x table 51, 52 is provided with a work carrier 57, 58 which work carriers 57, 58 are directed towards each other—as seen in the drawing. Each of them can accommodate a work piece 59, 60.

The machining of each work piece 59 again involves that the motions of the tools 26 in the x and y direction take place exclusively on the side of the stand 1 as illustrated in the foregoing. The motions of the work pieces 59, 60 in the z direction can take place fundamentally independently from each other. The same applies to the rotary and pivoting motion about the axes of rotation 55, 56. Regularly, this is however not desired, because identical work pieces are customarily machined in the same way.

The third embodiment illustrated in FIGS. 7 and 8 differs from the above-mentioned embodiments by the design of the stand with the x and y skids. The overall arrangement and design of the z skids 28 corresponds to the first embodiment according to FIGS. 1 to 3. Of course the z skids 44, 45 of the second embodiment according to FIGS. 4 to 6 may be used in the same way. In as much as the embodiment of a double-spindle machine tool according to FIGS. 7 and 8 uses component parts that are identical with the foregoing embodiments, the same reference numerals are used. If component parts are used that are functionally identical, but slightly differ constructionally, the same references are used, provided with a prime, there being no use of a separate, renewed description.

The x skid 10′ which is disposed on the stand 1′ centrically comprises a vertical intermediate rib 61 so that two pairs of y guide rails can be mounted side by side on the front end, allotted to the working area 7, of the x skid 10′. Two y skids 62, 63 are displaceably disposed on these y guide rails 16 by means of y guide shoes 17. Actuation of the y skids 62, 63 in the y direction takes place by means of y linear motors 62, 63, of which the primary parts in the form of coils are mounted on the y skids 62, 63, whereas the secondary parts 67 in the form of permanent magnets are mounted on the x skid.

Actuation of the x skid 10′ takes place by top and bottom x linear motors 68, of which the primary parts 69 in the form of coils are mounted on the x skid 10′ and the secondary parts 70 in the form of permanent magnets are mounted on the stand 1′. One of the tool holder spindles 20, 21 is disposed on each y skid 62, 63.

Regarding the mode of operation as compared to the first and second embodiments of FIGS. 1 to 3 and 4 to 6, it must be added that, due to the fact that the y skids 62, 63, and thus the tools 26 they carry, are independently displaceable in the y direction, also the machining motions in the y direction are independent of each other.

The fourth embodiment according to FIGS. 9 and 10 differs from the embodiment of FIGS. 7 and 8 by two x skids 71, 72 being mounted on the stand 1″ which are independent of each other. Actuation of the x skids 71, 72 takes place by x linear motors73, 74 which are independent of each other and of which the primary parts 75, 76 in the form of coils are mounted on the respective x skid 71 and 72, whereas the secondary parts 77, 78 in the form of permanent magnets are mounted on the front side of the stand 1″. Apart from that reference is made to the foregoing description. As regards the mode of operation, it must still be added that the tool holding spindles 20, 21 are drivable independently of each other also in the x direction.

FIGS. 11 and 12 correspond to FIGS. 5 and 6 of the second embodiment, with however a carrier bridge 79 being disposed between the rotary tables 51, 52 which is jointly drivable by both rotary tables 51, 52 by means of the correspondingly triggered x rotary drive motors 53, 54 for rotation about the x axes of rotation 55, 56 which are then in alignment with each other. Work carriers are disposed on the carrier bridge 79; they correspond to the work carriers 39, 40 of the first embodiment according to FIGS. 1 to 3, which is why the corresponding reference numerals have been used in FIGS. 11 and 12. These work carriers 39, 40 contribute to the work pieces 41, 42 being machined jointly and simultaneously.

In the claims:

1. A double-spindle machine tool, comprising
a frame-type stand (1; 1′; 1″)
at least one x skid (10; 10′; 71, 72) which is guided on the stand (1; 1′; 1″) for displacement in an x direction;
at least one y skid (15; 62, 63) which is displaceable in a y direction on the at least one x skid (10; 10′; 71, 72);
tool holder spindles (20, 21) which are non-displaceable in the z direction on the at least one y skid (15; 62, 63) for accommodation of tools (26) for machining work pieces (41, 42; 59, 60) that are located in a working area (7);
at least one z skid (28; 44, 45) which is displaceable in a z direction and located in the working area (7); and
two work carriers (39, 40; 57, 58) which are disposed on the at least one z skid (28; 44, 45) for accommodation of the work pieces (41, 42; 59, 60).

2. A double-spindle machine tool according to claim 1, wherein the work carriers (49, 40; 57, 58) are each disposed on a rotary table (33, 34; 51, 52) which is disposed on the at least one z skid (28; 44, 45).

3. A double-spindle machine tool according to claim 1 wherein only a single z skid (28) is provided.

4. A double-spindle machine tool according to claim 1 wherein two z skids (44, 45) are provided.

5. A double-spindle machine tool according to claim 1, wherein only a single x skid (10, 10′) is provided.

6. A double-spindle machine tool according to claim 1, wherein only a single y skid (15) is provided.

7. A double-spindle machine tool according to claim 5, wherein two y skids (62, 63) are provided.

8. A double-spindle machine tool according to claim 1, wherein two x skids (71, 72) are provided; and wherein a y skid (62, 63 is disposed on each x skid (71, 72).

9. A double-spindle machine tool according to claim 1, wherein at least one skid (10; 15; 28; 44, 45) is drivable by way of a ball screw (14; 19; 32; 50).

10. A double-spindle machine tool according to claim 1, wherein at least one skid (62, 63; 71, 72) is drivable by at least one linear motor (64, 65; 73, 74).

11. A double-spindle machine tool according to claim 2, wherein the rotary tables (33, 34) are each rotatable about a y axis of rotation (37, 38).

12. A double-spindle machine tool according to claim 2, wherein the rotary tables (51, 52) are drivable for rotation about an x axis of rotation (55, 56).
